(19) United States
(12) Patent Application Publication
(10) Pub. No.: US 2009/0249426 A1
(43) Pub. Date: Oct. 1, 2009

(54) SUPPLEMENTING BROADCAST SERVICE WITH NETWORK CONTENT

(75) Inventors: Shigeru Aoki, Tokyo (JP); Carlton Lane, Tokyo (JP); Alex Magzoumov, Tokyo (JP); Michimune Kono, Yokohama (JP)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/056,756

(22) Filed: Mar. 27, 2008

(51) Int. Cl. H04N 7/173

(52) U.S. Cl. 725/131; 725/105

(57) ABSTRACT

A broadcast interactive television service provides broadcast content received through a broadcast and supplemental content retrieved over a network. The broadcast content may include a broadcast markup language (BML) file which is parsed to provide an interface to the user. If the BML file contains information regarding the location or other information for supplemental content, the supplemental content can be retrieved from over a network and provide through the interface. Once presentation of the supplemental content has completed, the state of the interface may return to that associated with the BML file.

### BACKGROUND

With the development of computing devices and encoding of radio signals, television has evolved into an interactive experience. Some interactive television services may be provided as a radio band broadcast signal to subscribers of a broadcast service. The broadcast signal includes data for providing an interface on a television along with the programming content. A user may provide input to navigate the interface and view the content included in the signal. The interface may be described by a protocol, such as a broadcast markup language (BML), and include one or more pages that may be navigated by a user.

Though broadcast interactive TV services include an interactive interface, many interactive television services provided via broadcast signals do not allow users to retrieve additional content, such as video. Thus, broadcast television is typically a one-way service where a user can navigate the received content. As a result, most broadcast interactive TV services such as those using BML are limited in the content that they can provide.

### SUMMARY

The present technology, roughly described, includes a broadcast interactive television service able to provide supplemental content in addition to the broadcast content provided by a broadcast provider. A broadcast markup language (BML) file is received from a broadcast system and parsed to provide an interface to the user. The BML file may contain information regarding supplemental content that may be retrieved and provided in the interface. For example, the supplemental content may specify a network location at which archive video, images, or other supplemental content may be retrieved. When an interface selection corresponding to the supplemental content is received, the supplemental content is retrieved over the network and provided to the user.

A media application may be used to receive broadcast files using a tuner, provide an interface through a television and retrieve supplemental content over a network. The media application may process the broadcast file to provide an interface configured from the file. The browser may also determine if any supplemental content is available, retrieve the content from a remote server over a network, and provide the content through the interface. Once the content has completed, the media application restore the state of the interface to that associated with the broadcast file.

An embodiment of providing an interface receives a broadcast signal from a broadcasting source and parses the signal. The parsing is performed to detect an attribute in a first file contained in the broadcast signal. The attribute identifies a location of supplemental content. The supplemental content is retrieved from the identified location, over a network, determined from the parsing. The supplemental content is then provided through a user interface.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A illustrates a block diagram of an embodiment of a system for providing an interactive television service.

FIG. 1B illustrates a block diagram of another embodiment of a system for providing an interactive television service.

FIG. 2 illustrates a flow chart of an embodiment of a method for providing an interactive television service.

FIG. 3 illustrates a flow chart of an embodiment of a method for providing an interactive television interface to a user.

FIG. 4 illustrates a flow chart of an embodiment of a method for retrieving an MCML file.

FIG. 5 illustrates a flow chart of an embodiment of a method for providing MCML file content in an interactive television interface.

FIG. 6 is a block diagram of an embodiment of a broadcast-enabled electronic media device.

FIG. 7 illustrates a block diagram of an embodiment of a computing environment.

### DETAILED DESCRIPTION

A broadcast interactive television service provides supplemental content in addition to the broadcast content provided by a broadcast provider. A broadcast markup language (BML) file is received from a broadcast system and parsed to provide an interface to the user. The BML file may contain information regarding supplemental content that may be retrieved and provided in the interface. For example, the supplemental content may specify a network location at which archive video, images, or other supplemental content may be retrieved. When an interface selection corresponding to the supplemental content is received, the supplemental content is retrieved over the network and provided to the user.

Supplemental content provided in an interactive television service may be part of a media center markup language (MCML) file retrieved by an MCML application. The MCML file may describe the interface and how to present the content to a user. The supplemental content may be streaming video, images, or some other content. When the MCML file presentation has completed, the interface may return to a previously configured page of the interface, such as a page described by a BML file received from the broadcast provider.

In some embodiments, the supplemental content application includes a Microsoft Media Center hosted application, including but not limited to an MCML application. The supplemental data is accessed via the supplemental content application. For example, the supplemental data may include video data in any of several widely used video formats, including MPEG-1, MPEG-2, MPEG-4, H.264 (MPEG-4 AVC), and other video formats. Supplemental data may also include any image data in any of several widely used image formats, including JPEG, PNG, MNG, GIF, and other formats. Similarly, supplemental data may include audio data in any known audio format, including MPEG-2 Audio, AIFF-C (PCM), MPEG-4 Audio and other audio formats. These formats are listed as examples only, and other types of media formats may be used as supplemental data with the present technology.

A media application may be implemented on a computer or display device which receives broadcast and network files and provides an interface. The media application may include a BML browser and an MCML application. The BML browser may process a BML file received from a broadcast system. Once received, the BML browser may parse the file and provide an interface configured from the parsed file. The browser may also determine if any MCML file is available and pass information regarding an MCML file to another application if appropriate. The MCML application may retrieve an MCML file and provide supplemental content through the interface. The MCML application may retrieve the file from a remote server over a network and configure the interface to accommodate the retrieved MCML file content. Once the MCML content has completed, the MCML application may return control of the interface to the BML browser.

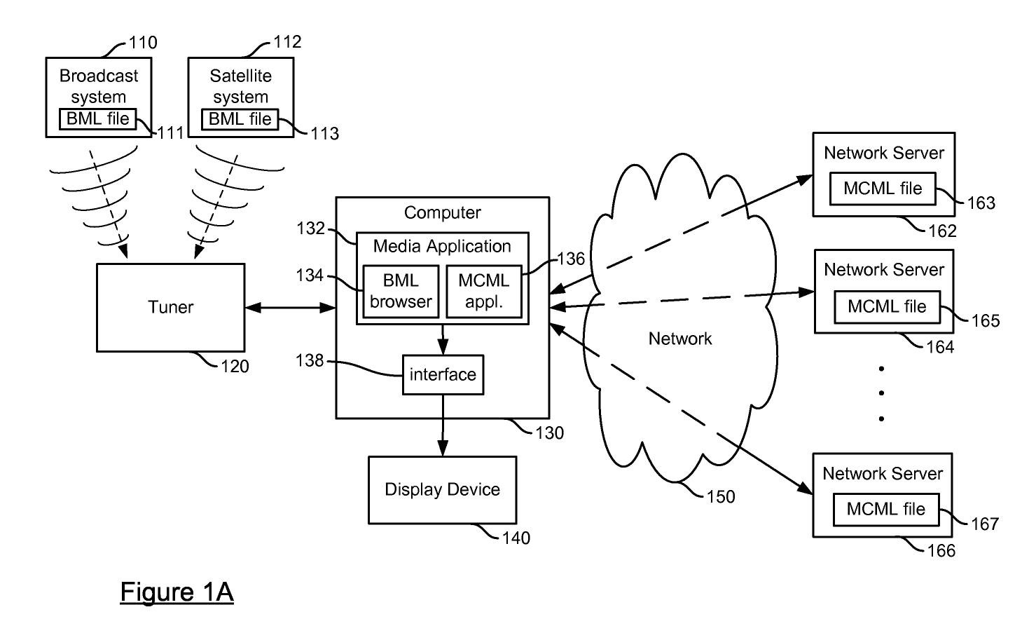

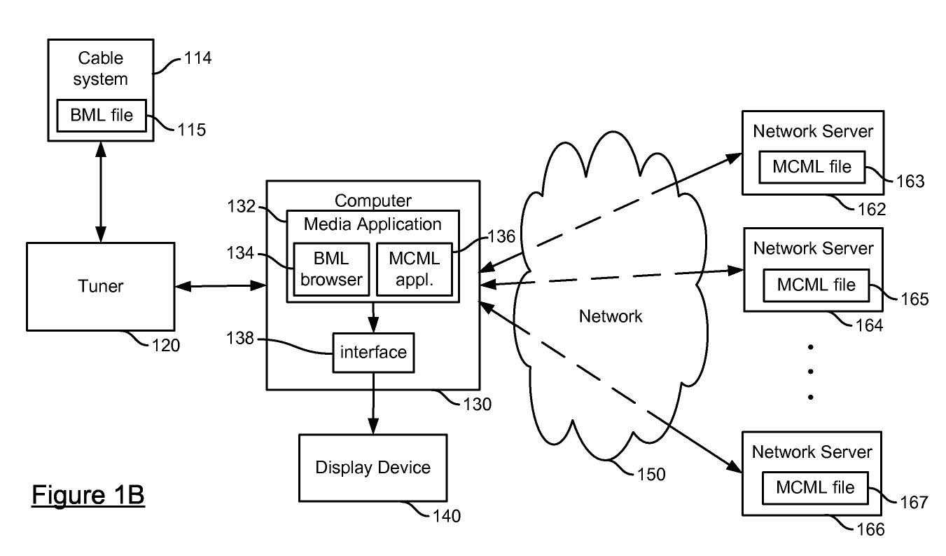

FIG. 1A illustrates a block diagram of an embodiment of a system for providing an interactive television service. The system of FIG. 1A includes broadcast system 110, satellite system 112, tuner 120, computer 130, display device 140, network 150, and network servers 162, 164 and 166.

Broadcast system 110 and satellite system 112 broadcast a signal over air to be received by tuner 120. The broadcast system may include one or more land based stations for broadcasting a radio signal to be received by tuners operated by subscribers of the broadcast system. The broadcast system receives programming content from different program sources associated with television channels. The content is then placed in a BML file and broadcast from a station dish to tuners tuned into the radio signal broadcast. The BML file may include content such as video, audio, images and other content, as well as data related to how to provide the content in an interface.

Satellite system 112 transmits a signal over air to tuner 120 utilizing one or more orbiting satellites. The one or more satellites in orbit broadcast a radio signal from space to tuners tuned into the radio signal frequency being broadcast. The signal transmitted by broadcast system 110 and satellite system 112 may be in a digital format and encrypted.

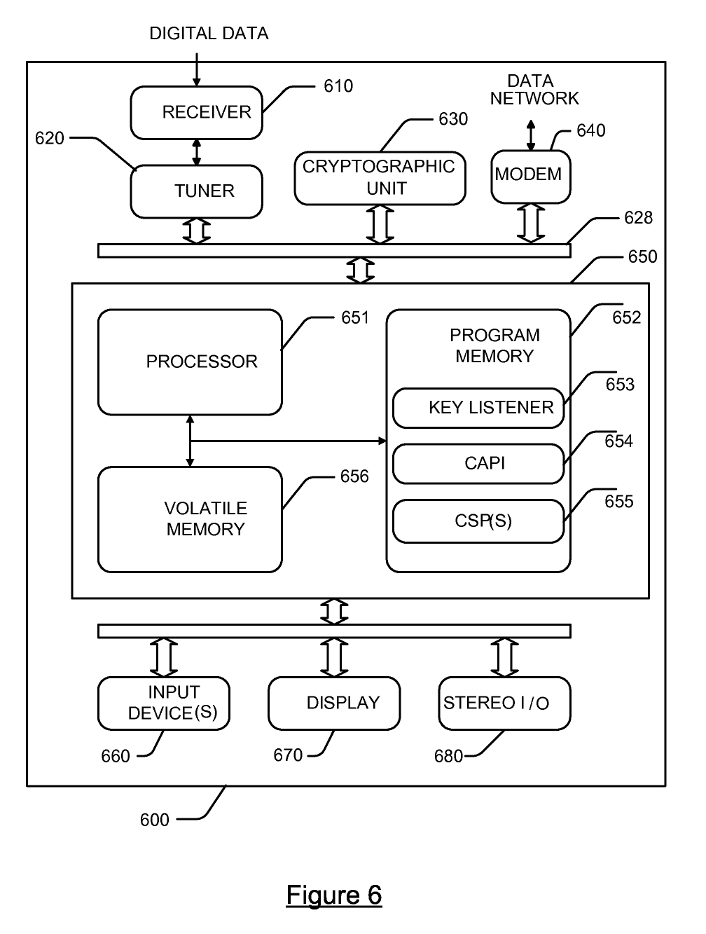

Tuner 120 receives a signal transmitted through air and provides the signal to computer 130. In some embodiments, tuner 120 may decrypt the received signal or perform other processing before providing the signal to computer 130. Tuner 120 is discussed in more detail below with respect to FIG. 6.

Computer 130 is in communication with tuner 120, display device 140 and one or more of network servers 162-166 over network 150. Computer 130 may include media application 132 and provide an interface 138 to display device 140. In some embodiments, Computer 130 may include tuner 120, which may be implemented as software, hardware, or a combination of both.

Media application 132 may be part of an operating system or an application running on an operating system that provides media content to be displayed through display device 140. Media application 132 may be implemented as a set of one or more applications, such as “Microsoft Windows Media Center,” by Microsoft Corporation, of Redmond, Wash.

In some embodiments, media application 132 includes BML browser 134 and MCML application 136. BML browser 134 may receive and process a BML file. In processing the BML file, BML browser 134 may configure and populate interface 138 with content contained in the BML file according to configuration information contained in the file. MCML application 136 may retrieve an MCML file from one or more of network servers 162-166 and configure interface 138 to provide content within the MCML file. In some embodiments, MCML application 136 may configure interface 138 to provide video content that is streamed from a network server.

Network 150 may be implemented as the Internet or other WAN, a LAN, intranet, extranet, private network or other network or networks.

Each of network servers 162-166 may be implemented as one or more servers, including one or more web servers, application servers, and/or database servers, and be accessed by computer 130 over network 150. Each network servers 162-166 includes one or more MCML files, such as MCML files 163, 165 and 167, respectively. An MCML file includes video, images and/or other content which may be provided in interface 138, as well as markup instructions indicating how to provide the content in the interface.

FIG. 1B illustrates a block diagram of another embodiment of a system for providing an interactive television service. The system of FIG. 1B is similar to that of FIG. 1A except that cable system 114 (rather than a broadcast system) provides a BML file 115 to tuner 120. In this case, the cable system includes components which provide content over a cable, telephone line, fiber optic line, or some other wired connection. Typically, the cable system does not provide the BML file to the receiver over air. Tuner 120 in this system may comprise a cable receiving box, software implemented on computer 130, or some other implementation of hardware and software which receives a signal provided by cable system 114.

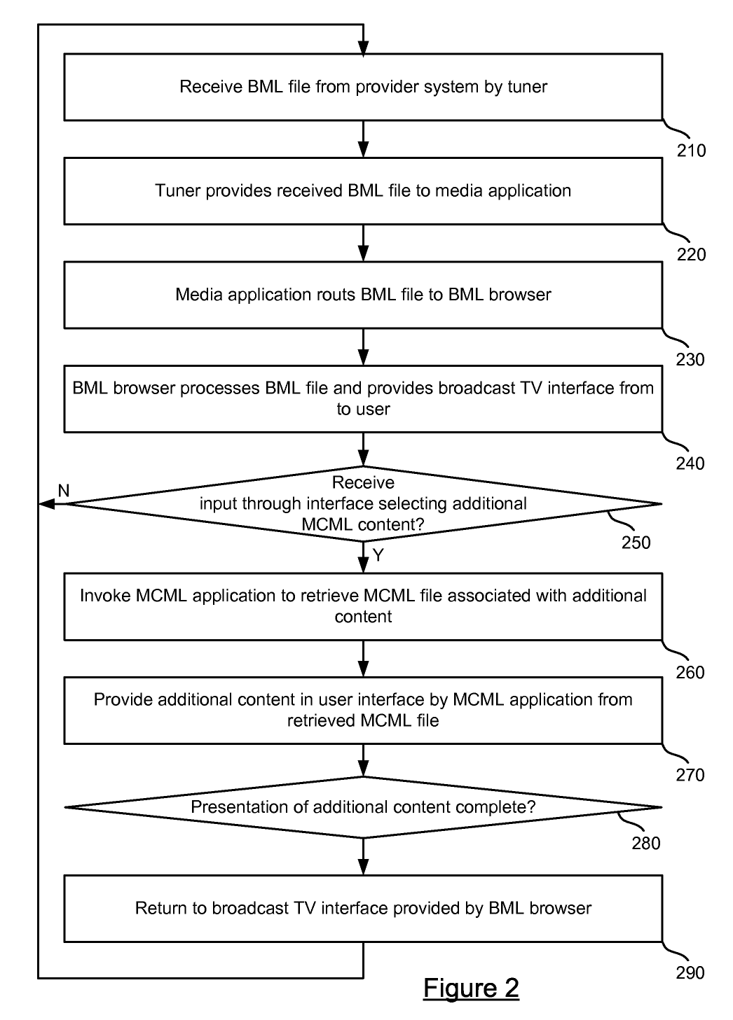

FIG. 2 illustrates a flow chart of an embodiment of a method for providing an interactive television service. The method of FIG. 2 is performed primarily by tuner 120 and computer 130. First, a BML file is received from a provider system by tuner 120 at step 210. In some embodiments, tuner 120 may receive the file over air from broadcast system 110 or satellite system 112. In some embodiments, tuner 120 may receive the file from cable system 114 through a cable, telephone line, or fiber optic line connection. Next, tuner 120 provides the received BML file to media application 132. Before providing the BML file, tuner 120 may decrypt the received file or otherwise process the file to prepare the file for processing by media application 132. To provide the BML file to media application 132, tuner 120 may transmit the file to computer 130 which may then route the file to media application 132.

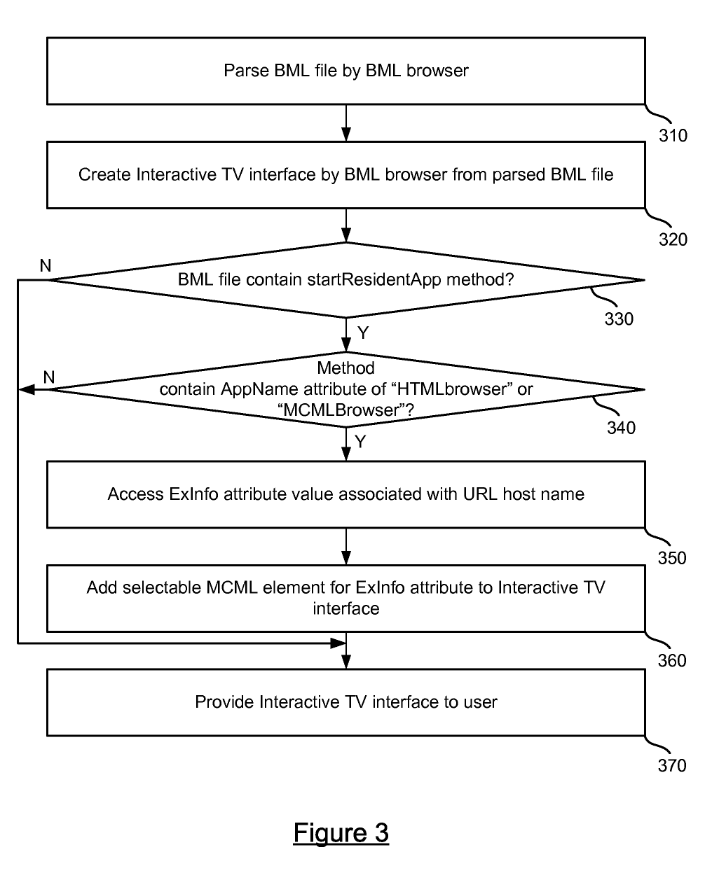

Media application 132 may route the received BML file to BML browser 134 at step 230. In some embodiments, media application 132 may perform processing of the file before forwarding the file. BML browser 134 may process the BML file and provide a broadcast television interface to a user at step 240. Processing of the file by the BML browser may include parsing the file. The broadcast television interface may include content contained in the BML file and have a format described by the file. Processing of the BML file and providing the broadcast television interface is described in more detail below with respect to FIG. 3.

A determination is made as to whether input is received through interface 138 which selects supplemental content at step 250. The supplemental content may be MCML content available at one or more network servers. When the received BML file indicates additional MCML content is available, a button, link or other selectable component may be included in interface 128. If a user selects the interface component associated with additional MCML content, the method of FIG. 2 continues to step 260. If no additional MCML content is available or input is not received selecting additional MCML content in the interface, the method of FIG. 2 returns to step 210 where the interface may be updated with a new BML file or the user may continue to navigate the current interface.

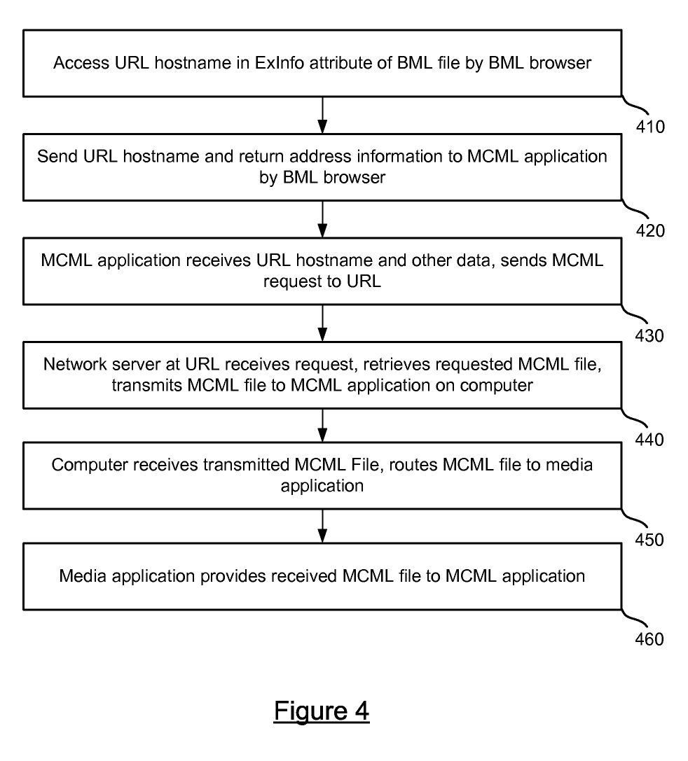

When input is received selecting additional MCML content, an MCML application is invoked to retrieve the MCML file associated with the supplemental content at step 260. In some embodiments, MCML application 136 is invoked by BML browser 134. The commands to invoke MCML application may include a URL location of the MCML file to retrieve, return address information indicating what interface to provide once the MCML content has completed, and other information. Invoking an MCML application to retrieve the MCML file is described in more detail below with respect to FIG. 4.

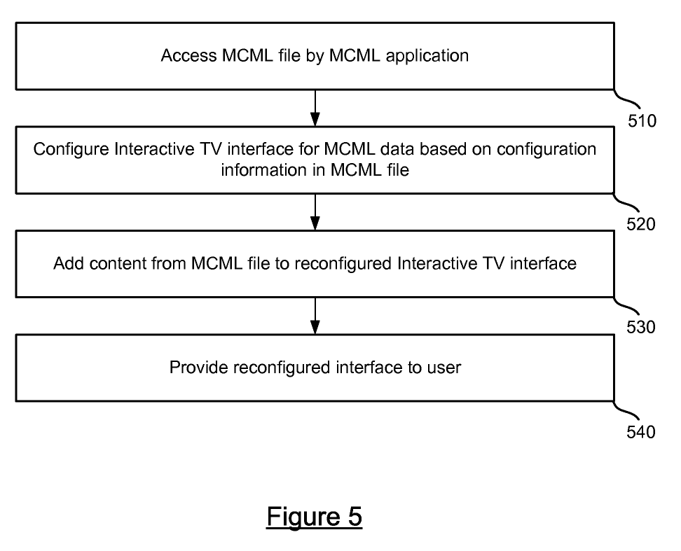

Supplemental content in a user interface is provided by MCML application 136 from a retrieved MCML file at step 270. In some embodiments, the supplemental content is provided in the same interface previously configured by BML browser 134. In other embodiments, the supplemental content is provided in a new window provided outside the interface. Providing supplemental content in a user interface by an MCML application is discussed in more detail below with respect to FIG. 5.

After providing the supplemental content, a determination is made as to whether the presentation of the supplemental content is complete at step 280. For example, when the supplemental content is a video stream, presentation of the content is complete when the video content being streamed to computer 130 has ended. If presentation of supplemental content is complete, the method continues to step 290. If presentation of supplemental content is not complete, then the method of FIG. 2 remains at step 280 until it is complete or input is received to stop providing the content.

After completing presentation of the supplemental content, the system returns to the broadcast TV interface provided by BML browser at step 290 and the method returns to step 210. Thus, after the content has ended, the interface returns to the interface configuration described by the BML file and configured by BML browser 134. In some embodiments, MCML application 130 determines that the streaming video has completed and provides a return address to BML browser 134 (the return address originally provided to MCML application 136 at step 260). For example, the return address information may specify that a second page of a three page interface is to be provided after a video stream has completed.

FIG. 3 illustrates a flow chart of an embodiment of a method for providing an interactive television interface to a user. In some embodiments, the method of FIG. 3 provides more detail for step 240 of the method of FIG. 2. First, a received BML file is parsed by BML browser 134 at step 310. An example of a BML file is below.

```
<?xml version=“1.0” encoding=“EUC-JP”?>
<!DOCTYPE bml PUBLIC “+//ARIB STD-B24:1999//DTD BML Document//JA”
      “http://www.arib.or.jp/B24/DTD/bml_1_0.dtd”>
<?bml bml-version=“3.0” ?>
<bml>
<head>
<title/>
<style><![CDATA[
      #video {top:0px;left:0px;width:480px;height:270px;}
      p.title {width:600px;left:100px;height:25px;
              color-index:4; grayscale-color-index:4 4;}
      p.item {width:600px;left:100px;height:25px;
              color-index:7; grayscale-color-index:4 4;}
      p:focus {background-color-index:6; }
]]></style>
<script><![CDATA[
function item1( ) {
  browser.launchDocument(“nullcheck.bml”,“cut”);
}
function item2( ) {
}
function item3( ) {
  browser.startResidentApp(“HTMLBrowser”, 1, “”,
“http://www.microsoft.com/en/us/default.aspx”);
}
function item4( ) {
  browser.startResidentApp(“MCMLBrowser”, 1, “”, “http://msmedia.weathernews.jp/”);
}
function dbutton( ) {
  browser.playRomSound(“romsound://2”);
}
]]></script>
<bevent>
<beitem id=“bevt0” type=“DataButtonPressed” onoccur=“dbutton( );”
subscribe=“subscribe”/>
</bevent>
</head>
<body id=“mybody” style=“background-color-index:7;”>
<div style=“width:960px;height:540px;”>
        <object id=“video” data=“/−1” type=“video/X-arib-mpeg2”/>
</div>
<p id=“t0” class=“title” style=“top:30px;”>BML Test Items</p>
<p id=“t1” class=“item” onclick=“item1( );” style=“nav-index:0;nav-down:1;nav-
up:3;top:100px;”>Null vs undefined</p>
<p id=“t2” class=“item” onclick=“item2( );” style=“nav-index:1;nav-down:2;nav-
up:0;top:140px;”>Infinite loop</p>
<p id=“t3” class=“item” onclick=“item3( );” style=“nav-index:2;nav-down:3;nav-
up:1;top:180px;”>startResidentApp(“HTMLBrowser”,...)</p>
<p id=“t4” class=“item” onclick=“item4( );” style=“nav-index:3;nav-down:0;nav-
up:2;top:220px;”>startResidentApp(“MCMLBrowser”,...)</p>
</body>
</bml>
```

The example BML file above includes generic URL host names in the following format: browser.startResidentApp(appName, showAV, returnURI, Ex_info)

For example, an appName of “HTMLbrowser” is listed for the method startResidentApp. The method has an Ex_info attribute of the URL “http://msmedia. weathernews.jp/.”

After parsing the BML file, an interactive TV interface is created by BML browser 134 from the parsed BML file at step 320. In some embodiments, the interface is created from script contained in the BML file. The interface allows a user to select program channels as well as supplemental content incorporated into the BML file, such as weather and other data.

A determination is made as to whether the BML file contains a “startResidentApp” method at step 330. This method indicates that an MCML file may be accessible to media application 132 over a network. In some embodiments, other methods or content could be used in the BML file to indicate that supplemental content such as an MCML files may be available to media application 132. If the BML file does not contain the identified method at step 330, the method of FIG. 3 continues to step 370. If the BML file does contain the identified method, the method of FIG. 3 continues to step 340.

A determination is made as to whether the method contains an “appName” attribute of “html browser” or “MCML browser” at step 340. The presence of either of these attributes indicates that an MCML file can be configured by the particular application identified as the attribute. If the method does not contain an “appName” within the attribute of a particular value, the method of FIG. 3 continues to step 370. If the method does contain an application name having an attribute of a particular value, then an “Ex_info” attribute value is accessed at step 350. This attribute value is associated with the URL host name at which the MCML file is being stored.

A selectable component is added to the interactive TV interface for the “Ex_info” attribute at step 360. The selectable component, such as a button, link, or other component, allows the user to provide input indicating that the MCML file should be retrieved and the content associated with that file provided in interface 138. After adding the component to the interactive TV interface, the interface is provided to a user at step 370. If the BML file does not contain the identified method and attribute as indicated at step 340, then the interactive TV interface is provided to user at step 370 without including a component associated with an MCML file.

FIG. 4 illustrates a flow chart of an embodiment of a method for retrieving an MCML file. The method of FIG. 4 provides more detail for step 260. A URL host name identified in the attribute of the BML file is accessed by BML browser 134 at step 410. This is the same attribute accessed at step 350 in the method of FIG. 3. Next, the URL host name and any return address information are transmitted to MCML application 136 by BML browser 134 at step 420. The URL host name is the location of the MCML file to be retrieved by MCML application 136. The return address information indicates what portion of an interface that BML browser 134 should provide once any content retrieved by MCML application 136 has been presented.

MCML application 136 receives the URL host name, return address information and any other data and sends an MCML request to the URL at step 430. The request may be sent to one or more of network servers 162-166 over network 150. A network server at the URL receives the request, retrieves the requested MCML file(s) and transmits the MCML file to MCML application 136 at step 440. In some embodiments, the content may be sent as a streaming video file to media application 132 on computer 130. Computer 130 receives the transmitted MCML file and routes the MCML file to media application 132 at step 450. Media application 132 provides the received MCML file to MCML application 136 at step 460.

FIG. 5 illustrates a flow chart of an embodiment of a method for providing an MCML file and corresponding content in an interactive television interface. In some embodiments, the method of FIG. 5 provides more detail for step 270 of the method of FIG. 2. First, an MCML file is accessed by MCML application 136 at step 510. Next, the interactive TV interface is configured from MCML data in the accessed MCML file. For example, interface 138 may be configured to provide a new window to provide streaming video for content contained in and described by the retrieved MCML file. Next, content from the MCML file is added to the reconfigured interactive TV interface at step 530. The reconfigured interface is then provided to the user at step 540. At this point, if the MCML file includes streaming video, the interface is provided to the user and the streaming video is played in the interface for the user. The interface is provided until the presentation of supplemental content is complete as discussed above at step 280 of the method of FIG. 2. Once the content is complete, MCML application 136 returns control of interface 138 to BML browser 134 along with return address information which may be used to configure interface 138 at step 290 of the method of FIG. 2.

FIG. 6 illustrates a block diagram of an embodiment of a tuner device 600. The tuner system of FIG. 6 provides more detail for the tuner 120 of the system of FIG. 1A.

In one embodiment, the device 600 may be used to implement client devices 110-130. Device 600 includes a central processing unit 650 having a processor 651, volatile memory 656 (e.g., RAM), and program memory 652 (e.g., ROM, Flash, disk drive, floppy disk drive, CD-ROM, etc.). The device 600 has one or more input devices 660 (e.g., keyboard, mouse, etc.), a video display 670 (e.g., VGA, SVGA), and a stereo I/O 680 for interfacing with a stereo system.

The device 600 includes a digital broadcast receiver 610 (e.g., satellite dish receiver, RF receiver, microwave receiver, multicast listener, etc.) and a tuner 620 which tunes to appropriate frequencies or addresses of the broadcast network. The tuner 620 is configured to receive digital broadcast data in a particularized format, such as MPEG-encoded digital video and audio data, as well as digital data in many different forms, including software programs and programming information in the form of data files. The device 600 also has a modem 640 which provides dial-up access to the data network 628 to provide a back channel or direct link to the server 650. In other implementations of a back channel, the modem 640 might be replaced by a network card, or an RF receiver, or other type of port/receiver which provides access to the back channel.

The device 600 runs an operating system which supports multiple applications. The operating system may be a multitasking operating system which allows simultaneous execution of multiple applications. The operating system may employ a graphical user interface windowing environment which presents the applications or documents in specially delineated areas of the display screen called “windows.”

The device is illustrated with a key listener 653 to receive the authorization and session keys transmitted from the server 650. The keys received by listener 653 are used by the cryptographic security services implemented at the device 600 to enable decryption of the session keys and data. Cryptographic services are implemented through a combination of hardware and software. A secure, tamper-resistant hardware unit 682 is provided external to the CPU 660 and two software layers 654, 655 executing on the processor 651 are used to facilitate access to the resources on the cryptographic hardware 630.

The software layers include a cryptographic application program interface (CAPI) 684 which provides functionality to any application seeking cryptographic services (e.g., encryption, decryption, signing, or verification). One or more cryptographic service providers (CSPs) implement the functionality presented by the CAPI to the application. The CAPI layer 654 selects the appropriate CSP for performing the requested cryptographic function. The CSPs 655 perform various cryptographic functions such as encryption key management, encryption/decryption services, hashing routines, digital signing, and authentication tasks in conjunction with the cryptographic unit 682. A different CSP might be configured to handle specific functions, such as encryption, decryption, signing, etc., although a single CSP can be implemented to handle them all. The CSPs 655 can be implemented as dynamic linked libraries (DLLs) that are loaded on demand by the CAPI, and which can then be called by an application through the CAPI 654.

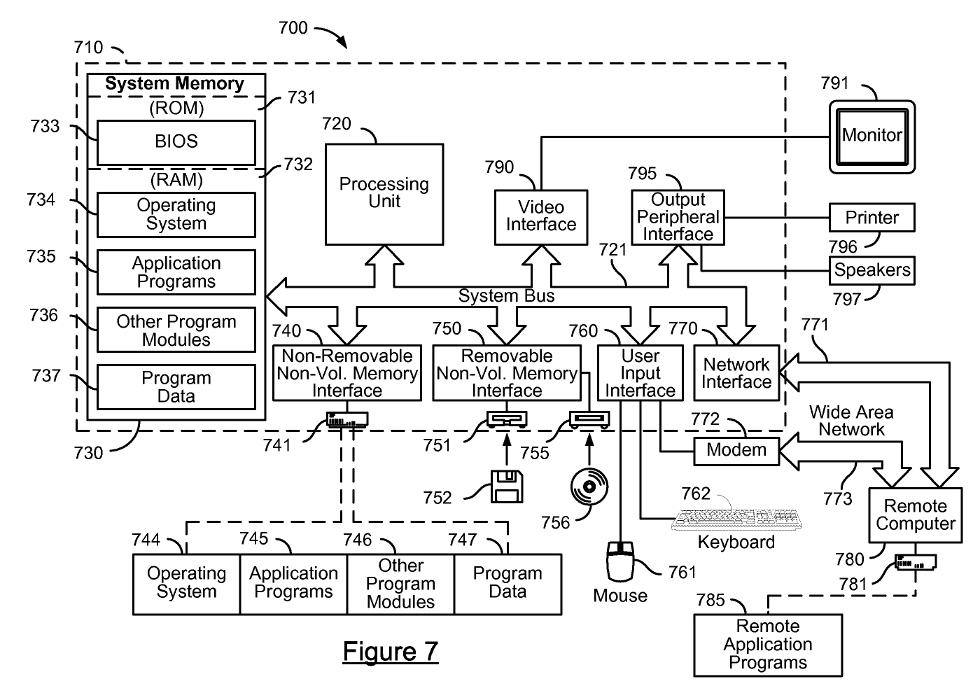

FIG. 7 illustrates a block diagram of an embodiment of a computing environment 700. In some embodiments, the computing environment of FIG. 7 may provide more detail for computer 130 and use of network servers 162-166.

Computing environment 700 of FIG. 7 is only one example of a suitable computing environment and is not intended to suggest any limitation as to the scope of use or functionality of the technology herein. Neither should the computing environment 700 be interpreted as having any dependency or requirement relating to any one or combination of components illustrated in the exemplary operating environment 700.

The technology described herein is operational with numerous other general purpose or special purpose computing system environments or configurations. Examples of well known computing systems, environments, and/or configurations that may be suitable for use with the technology herein include, but are not limited to, personal computers, server computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the technology herein includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 740 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 70 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 790.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A computer implemented method for providing an interface, comprising:
receiving a broadcast signal from a broadcasting source;
parsing the broadcast signal to detect an attribute in a first file contained in the broadcast signal, the attribute identifying a location of supplemental content;
retrieving the supplemental content from the identified location over a network; and
providing the supplemental content through a user interface.

2. The computer implemented method of claim 1, wherein the first file is a broadcast mark-up language file.

3. The computer implemented method of claim 1, wherein the first file includes data for configuring an interactive television interface.

4. The computer implemented method of claim 1, wherein the location is a uniform resource locator.

5. The computer implemented method of claim 1, further comprising:
configuring a first interface based on date in the first file; and
providing the first interface to a user,
the supplemental content provided through the first interface after the supplemental content is retrieved.

6. The computer implemented method of claim 1, wherein the request is sent in response to receiving a selection through a user interface, the selection associated with supplemental content.

7. The computer implemented method of claim 1, wherein said step of retrieving the supplemental content includes:
sending a request to a server at the location identified in the attribute; and
receiving a response with the supplemental content from the location.

8. The computer implemented method of claim 1, wherein the supplemental content includes streaming video content.

9. The computer implemented method of claim 1, further comprising:
detecting that the supplemental content provided through the user interface is complete; and
configuring the user interface using data in the first file contained in the broadcast signal, said step of configuring the user interface initiated in response to said step of detecting that the supplemental content is complete.

10. A computer implemented method for providing an interface, comprising:
receiving a first broadcast signal having a broadcast file, the broadcast file including information associated with a remote media file;
providing a first interface based on the broadcast file;
receiving a selection through the first interface, the selection associated with the remote media file;
retrieving the remote media file from a remote server in response to the received selection; and
providing the retrieved media file in the first interface.

11. The computer implemented method of claim 10, wherein the information associated with the remote media file includes the location of the media file.

12. The computer implemented method of claim 11, wherein the first broadcast signal is received by a tuner and provided to a computing device which provides the first interface.

13. The computer implemented method of claim 12, wherein the format of the interface is described by one or more attributes of the broadcast file.

14. The computer implemented method of claim 13, wherein the first interface includes one or more selectable components associated with a the remote media file.

15. The computer implemented method of claim 14, wherein the first interface provided based on the broadcast file is provided by a broadcast mark-up language browser.

16. The computer implemented method of claim 15, wherein the remote media file is retrieved by a media mark-up language application in communication with the broadcast mark-up language browser.

17. An apparatus for providing a user interface, comprising:
a storage device;
a first communication interface for communicating with a tuner;
a second communication interface for communicating with a remote network server;
a broadcast file browser for processing a broadcast file received through the first communication interface from a tuner, the broadcast file browser configured to provide an interface from the broadcast file; and
a media mark-up language application for retrieving a media file from the remote server through the second communication interface, the media mark-up language application configured to modify the interface to provide the retrieved media file.

18. The apparatus of claim 17, wherein the media mark-up language application is configured to be invoked by the broadcast file browser to retrieve the media file and control the interface, provide the media file through the interface as streaming video, and return control the of the interface to the broadcast file browser when the streaming video has completed.

19. The apparatus of claim 17, wherein the broadcast file includes the location of the media file.

20. The apparatus of claim 19, wherein the broadcast file browser is configured to invoke the media mark-up language application in response to receiving an interface selection associated with the media file.
